(19) United States
(12) Patent Application Publication
(10) Pub. No.: US 2002/0026378 A1
(43) Pub. Date: Feb. 28, 2002

(54) Golf ball ordering system, golf ball order receiving apparatus and golf ball order requesting terminal

(75) Inventor: Toshihiko Inoue, Tokyo (JP)

Correspondence Address: SUGHRUE, MION, ZINN, MACPEAK & SEAS, PLLC, 2100 Pennsylvania Avenue, N.W., Washington, DC, 20037-3202, US

(73) Assignee: BRIDGESTONE SPORTS CO., LTD.

(21) Appl. No.: 09/917,708

(22) Filed: Jul. 31, 2001

(30) Foreign Application Priority Data
Aug. 30, 2000 (JP) P.2000-261116

(51) Int. Cl. G06F 17/60

(52) U.S. Cl. 705/26

(57) ABSTRACT

An order requester accesses to any one of order receiving servers 2-1, 2-2 and 2-3 by using any one of terminals 1-1, 1-2 and 1-3 and a mobile phone 1-4 and orders marked balls each printed with a desired mark. When the order requester inputs order information to the terminal and sends the order information to the order receiving server, the terminal receives input support information, previous order information or confirmation request information from the order receiving server 2-1, 2-2 or 2-3 and displays the information.

### BACKGROUND OF THE INVENTION

1. Field of the Invention

The present invention relates to a golf ball ordering system for ordering golf balls each printed with a mark containing at least one of an optional character and an optional graphic design through a network.

2. Description of the Related Art

Golf balls each printed with a desired mark such as a name, a graphic design, or the like, are used popularly as an advertisement or as an anniversary gift as well as it allows a player to identify his or her own ball easily.

Heretofore, ordering of such balls each printed with the mark has been made by writing the contents of the mark on a predetermined order form over a counter of a golf goods shop or the like and sending the order form to a factory by facsimile or the like. On that occasion, it was necessary to designate a font and a character string of a name or the like to be printed when a mark of a character string was desired and it was necessary to draw a mark on the order form accurately when a mark of an optional graphic design was desired. On the other hand, various ordering systems by use of a network have been put into practice as Internet is popularly used so that it is possible to order mark-printed balls through the network.

In use of an order form, however, it was necessary to write a mark on the order form exactly every time even though balls printed with the same mark was ordered previously. Hence, the burden imposed on the ordering person was large. When ordering was made in the same shop, it was possible to use the mark written in the previous order form. It was, however, necessary to manage the previous order form in order to use the mark written on the previous order form. When the number of orders increased, the labor required for retrieving the previous order form increased. Hence, it was not always easy to order balls printed with a mark. Moreover, there was a limit in reduction of time of delivery after ordering because the order was placed on the order form.

When ordering is made by using a network, the ordering operation was also not easy as well as the contents of the order were limited. Moreover, the same mark as ordered previously could not be ordered efficiently.

### SUMMARY OF THE INVENTION

The present invention is devised to solve the aforementioned problem and an object thereof is to provide a golf ball ordering system by which golf balls each printed with a desired optional mark can be ordered easily.

According to a first aspect of the present invention, there is provided a golf ball ordering system for ordering golf balls each printed with a mark containing at least one of an optional character and an optional graphic design through a network, comprising:

an order receiving server for receiving order information of the golf balls each printed with the mark, the order receiving server connected to the network; and

a terminal being connectable to the network for sending the inputted order information to the order receiving server,

wherein when the order receiving server prompts the terminal to input the order information, the order receiving server sends mark input support information to the terminal for supporting input of contents of the mark.

According to a second aspect of the present invention, there is provided a golf ball ordering system for ordering golf balls each printed with a mark containing at least one of an optional character and an optional graphic design through a network, comprising:

an order receiving server connected to the network for receiving order information including receipt information for designating a method of receiving the golf balls each printed with the mark; and

a terminal being connectable to the network for sending the inputted order information to the order receiving server,

wherein when the order receiving server prompts the terminal to input the order information, the order receiving server sends receipt information input support information to the terminal for supporting input of the receipt information.

According to a third aspect of the present invention, there is provided a golf ball ordering system for ordering golf balls each printed with a mark containing at least one of an optional character and an optional graphic design through a network, comprising:

an order receiving server connected to the network for receiving order information of the golf balls each printed with the mark; and

a terminal being connectable to the network for sending the inputted order information to the order receiving server,

wherein when a new order through the terminal is placed by an order requester who had placed an order previously, the order receiving server sends previous order information of the order requester to the terminal.

### BRIEF DESCRIPTION OF THE DRAWINGS

FIG. 1 is a view showing the schematic configuration of a golf ball ordering system according to the present invention.

FIG. 2 is a view showing the schematic configuration of an example of the golf ball ordering terminal used in the present invention.

FIG. 3 is a view showing the schematic configuration of an example of the golf ball order receiving server used in the present invention.

FIG. 4 is a schematic flow chart showing the new order process.

FIG. 5 is a schematic flow chart showing the reorder process.

### DETAILED DESCRIPTION OF THE PREFERRED EMBODIMENTS

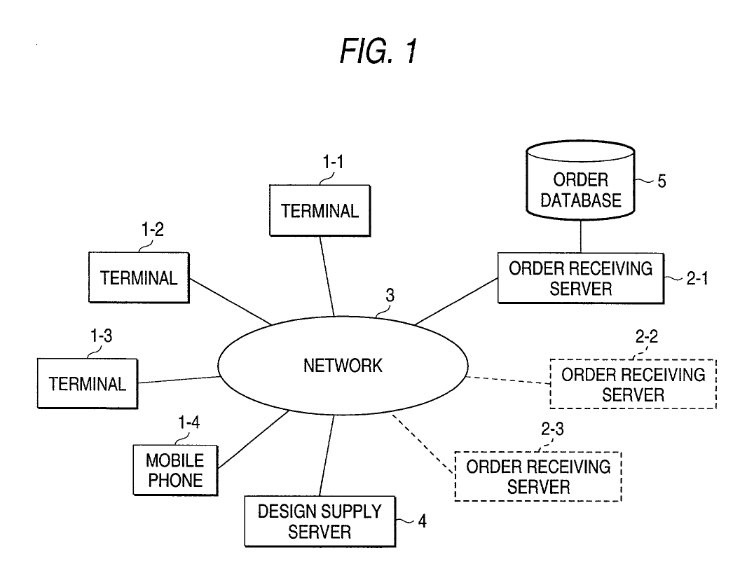

An embodiment of the present invention will be given with reference to FIGS. 1 to 5. FIG. 1 shows a schematic configuration of a golf ball ordering system according to the present invention. Each of terminals 1-1, 1-2 and 1-3 and a mobile phone 1-4 can be connected to a network 3 to order golf balls each printed with a mark (hereinafter referred to as marked balls) containing at least one of an optional character and an optional graphic design. For example, the terminal 1-1 is an ordering terminal which is installed in a golf goods shop such as a sports goods shop or the like. The terminal 1-1 can be also used for ordering other kinds of sports goods. The terminal 1-1 may serve also as a terminal for providing information concerning various kinds of sports. The terminal 1-2 is an ordering terminal which is installed in a commodity distributing shop such as a convenience store or the like. The terminal 1-2 can serve also as a terminal for performing other kinds of services. The terminal 1-3 is a computer such as a personal computer or the like which can be connected to a network.

Each of order receiving servers 2-1, 2-2 and 2-3 connected to the network 3 receives an order of marked balls. The order receiving server 2-1 is a server administrated by a golf ball maker. The order receiving server 2-2 is a server administrated by a golf goods shop. The order receiving server 2-3 is a server administrated by a network sales seller or a network sales intermediary agent. Incidentally, the order receiving servers 2-2 and 2-3 are not essential but are used for widening the order receiving route.

A design supply server 4 is provided for supplying a design to be printed on a golf ball. The design supply server 4 may be administrated by an administrator of an order receiving server or maybe administrated by a theme park, an entertainment production company or the like. When the design to be printed is provided from such a separate server so that the design can be referred to, characters can be administrated steadily by the theme park, the entertainment production company or the like, as well as the administration burden imposed on the ball maker can be lightened.

An order database 5 is a database to which the order receiving server 2-1 can access. Order information concerning the previous order of the marked balls is stored in the order database 5. The order information contains information for identifying the order requester, ball identification information for identifying the kind of the ordered ball, information concerning the contents of the mark to be printed, receipt information, settlement information, and so on. Name, address, telephone number and electronic mail address can be used as the information for identifying the order requester. After reception of the order, an ID code may be assigned to the order requester. The ball identification information may contain a play number to be printed on each of the balls as well as the brand name of the ball and the compression of the ball. The receipt information is provided for designating the method of receiving the ordered marked ball. Whether the ordered marked balls will be received at the golf goods shop or at the commodity distributing shop such as the convenience store or whether it will be delivered to the requester's home or not can be designated in the receipt information. Payment by cash at the shop where the ordered balls can be received, payment at the time of delivering the ordered balls to the requester's home, payment by a credit card, payment by adding the charge of the balls to the mobile phone charges, or the like, can be designated as the settlement information.

The outline of the method of using the system depicted in FIG. 1 is as follows. An order requester makes access to any one of the order receiving servers 2-1, 2-2 and 2-3 by using any one of the terminals 1-1, 1-2 and 1-3 and the mobile phone 1-4 and orders marked balls each printed with a desired mark. When the order requester inputs order information to the terminal and sends the order information, the terminal receives input support information, previous order information or confirmation request information from the order receiving server 2-1, 2-2 or 2-3 and displays the information so that the order requester can order the desired marked balls speedily and exactly. The information will be described later.

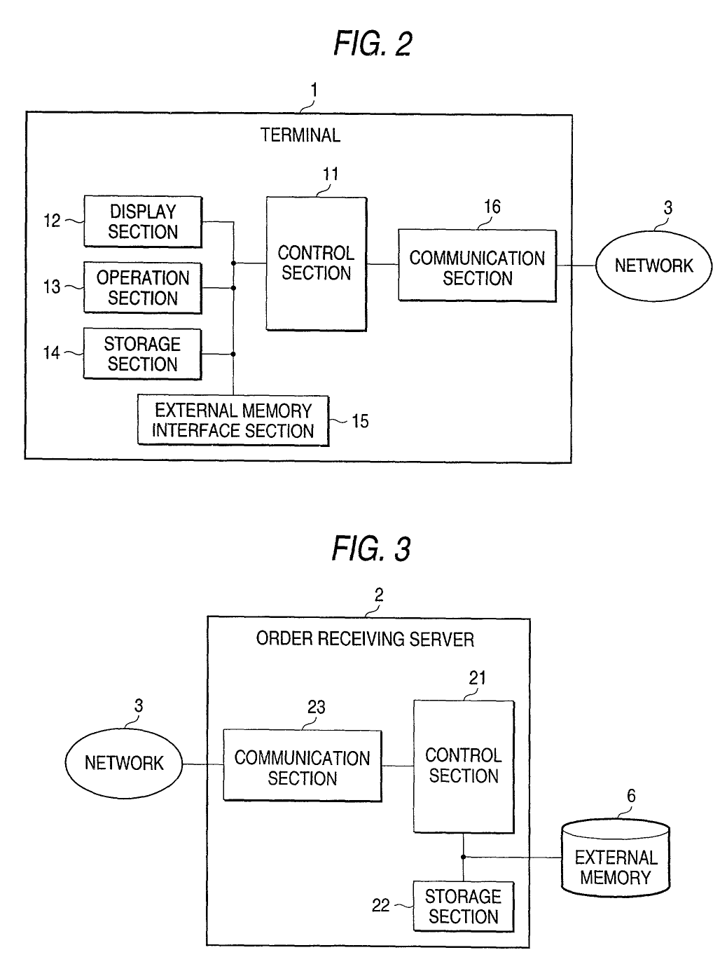

FIG. 2 shows a schematic configuration of an example of the order requesting terminal. In FIG. 2, the terminal 1 includes a control section 11, a display section 12, an operation section 13, a storage section 14, an external memory interface section 15, and a communication section 16. The terminal 1 can be used as each of the terminals 1-1, 1-2 and 1-3 depicted in FIG. 1.

The operation section 13 is used when the order requester inputs various kinds of instructions or data by using the terminal 1. The operation section 13 is constituted by a touch panel, a keyboard, etc. The storage section 14 is used for storing information transmitted from the order receiving server and for storing programs and is used as various kinds of work areas or the like when the terminal 1 is operating. The control section 11 is used for controlling the total operation of the terminal 1. Specifically, the control section 11 contains mainly a processor which operates in accordance with the programs stored in the storage section 14. The display section 12 is used for displaying various kinds of information. The communication section 16 is used for controlling transmission/reception of data through the network 3. Although the external memory interface section 15 is used when a design or the like to be printed on the balls is inputted from another medium, the external memory interface section 15 may be omitted.

The mobile phone 1-4 includes functional elements which are basically equivalent to those of the control section 11, the display section 12, the operation section 13, the storage section 14 and the communication section 16 in FIG. 2. Hence, the mobile phone 1-4 can be used as an ordering terminal like each of the terminals 1-1, 1-2 and 1-3. Moreover, the user can be surely identified by telephone number and payment can be made by addition of the charge of the balls to mobile phone charges. Hence, the ordering process can be simplified.

FIG. 3 shows a schematic configuration of an example of the order receiving server. In FIG. 3, the order receiving server 2 includes a control section 21, a storage section 22, and a communication section 23. The order receiving server 2 can be used as each of the order receiving servers 2-1, 2-2 and 2-3 depicted in FIG. 1.

The storage section 22 is used for storing information transmitted from the order receiving server, storing input support information which will be described later, storing previous order information received by the order receiving server, and storing programs. The storage section 22 is used as various kinds of work areas when the terminal 1 is operating. The control section 21 is used for controlling the total operation of the order receiving server 2. Specifically, the control section 21 contains mainly a processor which operates in accordance with the programs stored in the storage section 22. The communication section 23 is used for controlling transmission/reception of data through the network 3.

An external memory 6 can be connected to the order receiving server 2 as occasion demands. Input support information or the like which will be described later may be stored in the external memory 6 so that the input support information can be read as occasion demands.

Information prepared originally by the administrator of the order receiving server may be used as the input support information stored in the storage section 22 or in the external memory 6. For example, this is applied to the case where a person having the exclusive right of use of a character design, such as a theme park administration company, an entertainment production company, or the like, makes network sales through the order receiving server 2-3. In the order receiving server 2-2 administrated by a golf goods shop or in the order receiving server 2-3 administrated by a convenience store chain which makes also network sales, the receipt information may be the input support information set to the own store by default.

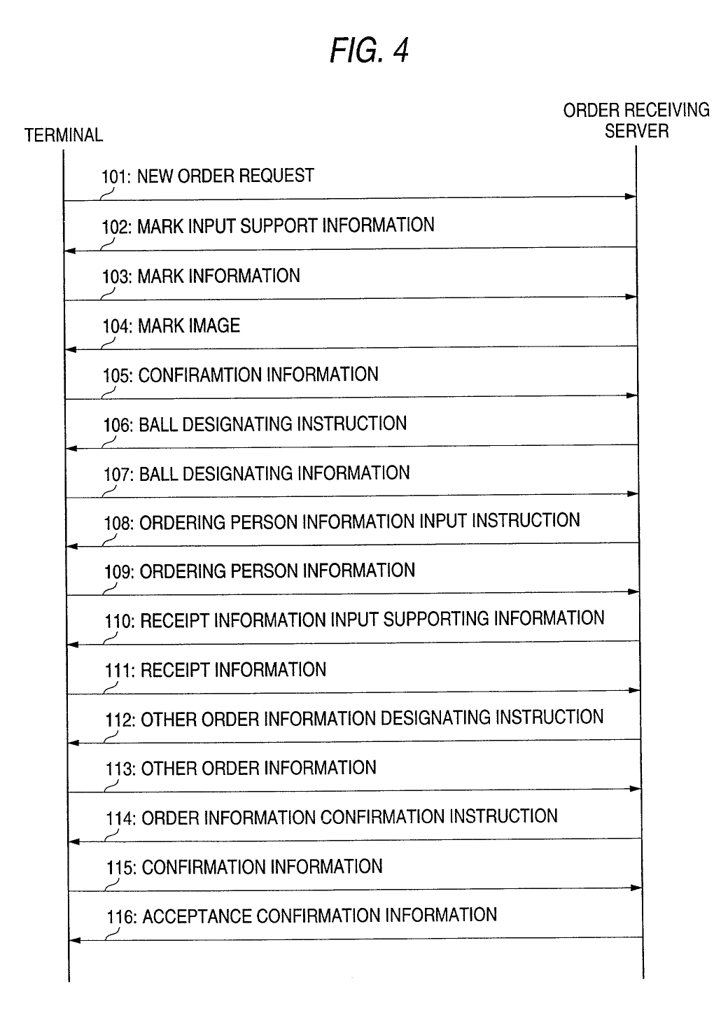

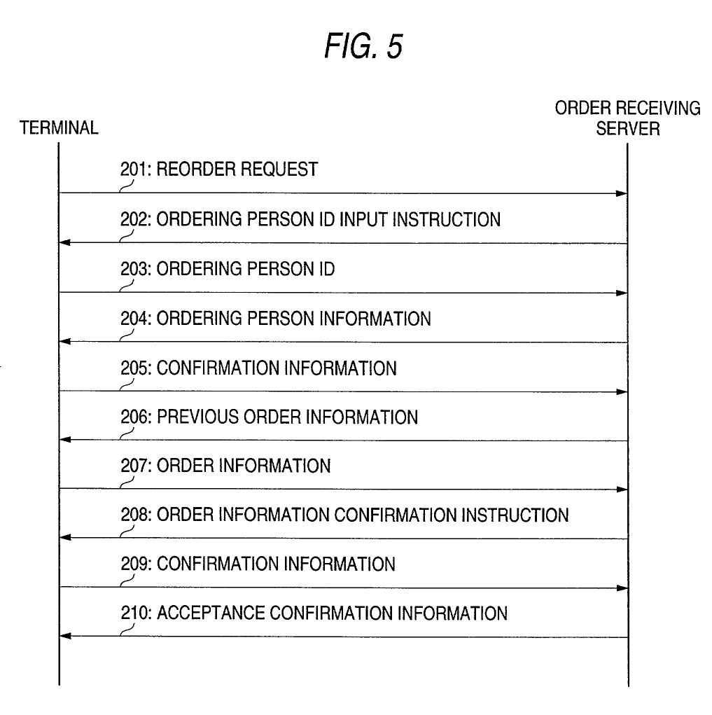

A schematic flow of the ordering process in the case where the marked golf balls are ordered by use of the order receiving server 2 will be given with reference to FIGS. 4 and 5. FIG. 4 is a flow chart showing the case where a new order is placed. FIG. 5 is a flow chart showing the case where a re-order is placed. In each of FIGS. 4 and 5, the order receiving server is any one of the order receiving servers 2-1, 2-2 and 2-3.

In FIG. 4, when an order requester orders marked golf balls, the order requester accesses to the order receiving server 2-1 (any one of the order receiving servers 2-1, 22 and 2-3 if the order receiving servers 2-2 and 2-3 are also provided) by using any one of the terminals 1-1, 1-2 and 1-3 and the mobile phone 1-4. When the order receiving servers 2-2 and 2-3 are also provided, the ordering terminal 1-1 installed in a golf goods shop may be provided so that the ordering terminal 1-1 can exclusively access to the order receiving server 2-2 administrated by the golf goods shop, and the ordering terminal 1-2 installed in a commodity distributing shop such as a convenience store, or the like, may be provided so that the ordering terminal 1-2 can exclusively access to the server 2-3 administrated by a chain of shops including the shop.

When a new order is placed (step 101) after the terminal is connected to a predetermined order receiving server, mark input support information is transmitted to the terminal from the server (step 102). The mark input support information contains information of character font (inclusive of font size) allowed to be used for making the mark, exemplification of character strings (character strings for hole-in-one memorial, shop's opening day, etc.), information of designs prepared in advance, information for supporting generation or input of design information on the ordering person's terminal, price information in accordance with the contents of the mark, and so on. All the aforementioned kinds of mark input support information are not sent together but only necessary kinds of information are sent in accordance with the ordering person's request.

The information of font allowed to be used for making the mark can be sent with font samples. Information prepared originally by the order receiving server may be used as the design information. Further, design information managed by the design supply server 4 may be provided. Information of design size, color, etc., allowed to be printed, data format of the design, generation template, and so on, may be provided as the generation or input support information. The price information in accordance with the contents of the mark is particularly required when a character design or the like is used. Hence, it is reasonable to offer a price which is obtained by adding the price of the mark to the price of the golf balls without any mark.

The ordering person makes the mark input support information displayed on the display section of the terminal, selects or generates a mark to be printed and sends the decided mark information to the order receiving server (step 103). In order to confirm the contents of the received mark, the order receiving server sends image information of the mark to be printed on the ball image to the terminal (step 104). In the step 104, image information of a marked ball synthesized from the mark image on the ball image may be sent. The ordering person sends confirmation information to the order receiving server when the ordering person confirms that the mark image information displayed on the terminal coincides with that of the ordered balls (step 105).

Then, selection instruction information for selecting the balls to be printed with the mark is sent from the order receiving server to the terminal (step 106). Specifically, a list of balls allowed to be ordered is sent together with an ordering check section, an order quantity input section and a desired ball play number input section. The ordering person checks or inputs necessary sections to the terminal and sends the checked or inputted data as ball designation information (step 107).

Then, the order receiving server sends ordering person information input instruction information for identifying the ordering person (step 108). Specifically, information for making the ordering person fill out the sections of name, address, telephone number, electronic mail address, etc. is sent to the terminal to prompt the ordering person to fill out these sections in the terminal. The ordering person information inputted thus is sent from the terminal to the order receiving server (step 109).

Then, receipt information input support information for designating the method of receiving the marked balls is sent from the order receiving server to the terminal (step 110). This information is provided for making the ordering person select one from receipt in a golf goods shop, receipt in a commodity distributing shop such as a convenience store and delivery to the ordering person's home. The number of selecting options may be reduced in accordance with the kinds (classified by administrators) of the order receiving servers. When the golf goods shop or the commodity distributing shop is selected, a list of shops is indicated for further selection. When the price varies in accordance with the receipt method, ball price information is sent in association with options for selecting the receipt method. It is reasonable to offer information of the price obtained by adding the price for the receipt method to the price of the marked balls. The ordering person inputs the information of the receipt method to the terminal and sends the information to the order receiving server (step 111).

Finally, the order receiving server sends designation instruction information for designating other order information such as settlement information (step 112) to make the ordering person designate the settlement information in the terminal (step 113). Then, order information confirmation instruction information for confirming all the order information designated until now is sent to the terminal (step 114). Then, when confirmation information is sent from the terminal to the order receiving server (step 115), the completion of order receiving is sent as order receipt confirmation information (step 116). Thus, the order receiving process is terminated. On this occasion, the ordering person's ID stored in the order database 5 is also sent to the terminal.

Although FIG. 4 shows the case where various kinds of order information are inputted and sent individually in a sequence of mark image, ball designation, ordering person information, receipt information and other order information. This sequence may be changed from the order receiving server side. Alternatively, only items may be prepared so that the items can be inputted and sent in a sequence of items selected by the ordering person. Further, data may be inputted all together and sent collectively.

The order information received by the order receiving server is sent to a ball-making factory. In the factory, the ordered mark is printed on the ordered ball. The marked balls are delivered to the ordering person by the designated method. A delivery time from the order receiving point of time cannot be determined uniquely because it varies in accordance with the time of production and the method of delivery. However, if the system is configured so that the order receiving server acquires the situation of the production site, the situation of the production site can be sent as order support information to the terminal at the time of order receiving.

Further, the order information is stored in the order database 5 connected to the order receiving server 2-1 managed by the golf ball maker so that the order information can be used for facilitating reception of the ordering person's reorder.

A flow of a reorder will be described below. In FIG. 5, when the ordering person is to reorder the marked balls, the ordering person accesses to the order receiving server 2-1 (any one of the order receiving servers 2-1, 2-2 and 2-3 if the order receiving servers 2-2 and 2-3 are also provided) by using any one of the terminals 1-1, 1-2 and 1-3 and the mobile phone 1-4. Also in the reordering, selection from the terminals 1-1, 1-2 and 1-3 and the mobile phone 1-4 and selection from the order receiving servers 2-1, 2-2 and 23 is the same as in FIG. 4.

When a re-order (repeat order) is requested (step 201) after the terminal is connected to the predetermined order receiving server, ordering person ID input instruction information is sent from the server to the terminal (step 202). The ordering person ID is identification information which is indicated to the ordering person when the order is completed. The ordering person ID is recorded in association with the order information in the order database 5. The ordering person ID is not always necessary so long as access to the order database 5 may be made on the basis of name and address information.

When the ordering person ID is sent from the terminal to the order receiving server (step 203), the order receiving server accesses to the order database 5 and fetches order information in association with the ordering person ID. The access of the order receiving server 2-2 or 2-3 to the order database 5 is performed through the order receiving server 2-1. If the sent ordering person ID does not match the person ID recorded in the database 5, the situation of the routine goes to the flow of ordering shown in FIG. 4. If the ordering person ID sent thus is recorded in the database 5, ordering person information corresponding to the ordering person ID is sent to the terminal (step 204) to make the ordering person confirm After checking the sent information such as name, address, etc., the ordering person sends confirmation information to the order receiving server (step 205).

Upon reception of the confirmation information, the order receiving server fetches corresponding order information from the order database 5 and sends the order information to the terminal (step 206). On this occasion, although all the order information can be sent as the information to be sent, the order information may be sent partially. The information of the mark allowed to be printed is, however, set necessarily. Further, if previous orders had been placed by a plurality of number of times, all the previous order information is sent to the terminal.

After the ordering person makes correction or additional input by referring to the previous order information displayed on the display device of the terminal, the ordering person sends it as new order information (step 207). Confirmation may be required whenever correction or additional input is made.

Then, order information confirmation instruction information is sent to the terminal (step 208), conformation information is sent from the terminal to the server (step 209) and completion of the order is sent as order receiving confirmation information to the terminal (step 210). The steps 208 to 210 are the same as in the flow chart shown in FIG. 4.

As is obvious from the above description, in accordance with the present invention, golf balls each printed with a desired optional mark can be ordered easily.

What is claied is:

1. A golf ball ordering system for ordering a golf ball printed with a mark containing at least one of an optional character and an optional graphic design through a network, comprising:
an order receiving server for receiving order information of said golf ball printed with said mark, the order receiving server connected to said network; and
a terminal being connectable to said network, the terminal for sending said inputted order information to said order receiving server,
wherein, when said order receiving server prompts said terminal to input said order information, said order receiving server sends mark input support information to said terminal for supporting input of contents of said mark.

2. The golf ball ordering system according to claim 1, wherein said mark input support information includes font information allowed to be used in said character included in said mark.

3. The golf ball ordering system according to claim 2, wherein said font information includes exemplification of fonts.

4. The golf ball ordering system according to claim 1, wherein said mark input support information includes exemplification of the character included in said mark.

5. The golf ball ordering system according to claim 1, wherein said mark input support information includes graphic design information allowed to be used as said mark.

6. The golf ball ordering system according to claim 5, wherein said graphic design information is obtained from another server which is connected to said network for supplying graphic design information.

7. The golf ball ordering system according to claim 1, wherein said mark input support information includes information for sending a graphic design to be used for making said mark from said terminal.

8. The golf ball ordering system according to claim 1, wherein said mark input support information includes price information in accordance with said contents of said mark.

9. The golf ball ordering system according to claim 1, wherein said order receiving server sends confirmation information including image information on the basis of said inputted contents of said mark to said terminal after said order receiving server has received said order information.

10. The golf ball ordering system according to claim 1, wherein said order information includes information for designating a kind of a ball and including designation of a play number.

11. A golf ball ordering system for ordering a golf ball printed with a mark containing at least one of an optional character and an optional graphic design through a network, comprising:
an order receiving server for receiving order information including receipt information for designating a method of receiving said golf ball printed with said mark, the order receiving server connected to said network; and
a terminal being connectable to said network, the terminal for sending said inputted order information to said order receiving server,
wherein, when said order receiving server prompts said terminal to input said order information, said order receiving server sends receipt information input support information to said terminal for supporting input of said receipt information.

12. The golf ball ordering system according to claim 11, wherein said receipt information input support information includes price information in accordance with the method of receiving said golf ball.

13. A golf ball ordering system for ordering a golf ball printed with a mark containing at least one of an optional character and an optional graphic design through a network, comprising:
an order receiving server for receiving order information of said golf ball printed with said mark, the order receiving server connected to said network; and
a terminal being connectable to said network, the terminal for sending said inputted order information is sent to said order receiving server,
wherein, when a new order through said terminal is placed by an order requester who had placed an order previously, said order receiving server sends previous order information of said order requester to said terminal.

14. The golf ball ordering system according to claim 13, further comprising a mark print order database in which said order information of said golf ball printed with said mark is centralized administrated, wherein said order receiving server uses said mark print order database to determine whether said order is from said previous order requester or not.

15. The golf ball ordering system according to claim 13, wherein said previous order information can be corrected in said terminal and corrected order information is sent to said order receiving server.

16. A golf ball order receiving apparatus for receiving an order of a golf ball printed with a mark containing at least one of an optional character and an optional graphic design through a network, comprising:
an order receiving server for receiving order information of said golf ball printed with said mark, the order receiving server connected to said network; and
a storage device for storing mark input support information for supporting input of contents of said mark;
wherein when said order receiving server receives an order request from a terminal connected to said network, said order receiving server sends said mark input support information to said terminal.

17. The golf ball order receiving apparatus according to claim 16, wherein said mark input support information includes font information allowed to be used in said character included in said mark.

18. The golf ball order receiving apparatus according to claim 17, wherein said font information includes exemplification of fonts.

19. The golf ball order receiving apparatus according to claim 16, wherein said mark input support information includes exemplification of a character included in said mark.

20. The golf ball order receiving apparatus according to claim 16, wherein said mark input support information includes graphic design information allowed to be used as said mark.

21. The golf ball order receiving apparatus according to claim 20, wherein said graphic design information is obtained from another server which is connected to said network for supplying graphic design information.

22. The golf ball order receiving apparatus according to claim 16, wherein said mark input support information includes information for sending a graphic design to be used for making said mark from said terminal.

23. The golf ball order receiving apparatus according to claim 16, wherein said mark input support information includes price information in accordance with said contents of said mark.

24. The golf ball order receiving apparatus according to claim 16, wherein said order receiving server sends confirmation information including image information on the basis of said inputted contents of said mark to said terminal after said order receiving server has received said order information.

25. The golf ball order receiving apparatus according to claims 16, wherein said order information includes information for designating a kind of a ball and including designation of a play number.

26. A golf ball order receiving apparatus for receiving an order of a golf ball printed with a mark containing at least one of an optional character and an optional graphic design through a network, comprising:
an order receiving server for receiving order information of said golf ball printed with said mark, the order receiving server connected to said network; and
a storage device for storing receipt information input support information for supporting input of receipt information for designating a method of receiving said golf ball printed with said mark,
wherein when said order receiving server receives an order request from a terminal connected to said network, said order receiving server sends said receipt information input support information to said terminal.

27. The golf ball order receiving apparatus according to claim 26, wherein said receipt information input support information includes price information in accordance with the method of receiving said golf ball.

28. A golf ball order receiving apparatus for receiving an order of a golf ball printed with a mark containing at least one of an optional character and an optional graphic design through a network, comprising an order receiving server connected to said network for receiving order information of said golf ball printed with said mark, wherein when an order through a terminal connected to said network is placed by an order requester who had placed an order previously, said order receiving server sends previous order information of said order requester to said terminal.

29. The golf ball order receiving apparatus according to claim 28, wherein said order receiving server can access to a mark print order database in which said order information of said golf ball printed with said mark is centralized administrated; and
said order receiving server uses said mark print order database to determine whether said order is from said order requester or not.

30. The golf ball order receiving apparatus according to claim 28,
wherein said previous order information can be corrected in said terminal; and
said order receiving server receives said corrected order information.

31. A golf ball order requesting terminal for requesting an order of a golf ball printed with a mark containing at least one of an optional character and an optional graphic design through a network, comprising:
a display section for displaying mark input support information for supporting input of contents of said mark, said mark input support information sent from an order receiving server connected to said network; and
means for generating order information including said contents of said mark inputted on the basis of said mark input support information displayed on said display section, said generated order information sent to said order receiving server.

32. The golf ball order requesting terminal according to claim 31, wherein said mark input support information includes font information allowed to be used in said character included in said mark.

33. The golf ball order requesting terminal according to claim 32, wherein said font information includes exemplification of fonts.

34. The golf ball order requesting terminal according to claim 31, wherein said mark input support information includes exemplification of a character included in said mark.

35. The golf ball order requesting terminal according to claim 31, wherein said mark input support information includes graphic design information allowed to be used as said mark.

36. The golf ball order requesting terminal according to claim 35, wherein said graphic design information is obtained from another server which is connected to said network for supplying graphic design information.

37. The golf ball order requesting terminal according to claim 31, wherein said mark input support information includes information for sending a graphic design to be used for making said mark from said terminal.

38. The golf ball order requesting terminal according to any one of claim 31, wherein said mark input support information includes price information in accordance with said contents of said mark.

39. The golf ball order requesting terminal according to any one of claim 31, wherein said display section displays confirmation information sent from order receiving server, said confirmation information including image information on the basis of said inputted contents of said mark.

40. The golf ball order requesting terminal according to claim 31, wherein said order information includes information for designating a kind of a ball and including designation of a play number.

41. A golf ball order requesting terminal for requesting an order of a golf ball printed with a mark containing at least one of an optional character and an optional graphic design through a network, comprising:
a display section for displaying receipt information input support information for supporting input of receipt information for designating a method of receiving said golf ball printed with said mark, said receipt information sent from an order receiving server connected to said network; and
means for generating order information including said receipt information inputted on the basis of said receipt information input support information displayed on said display section, said generated order information sent to said order receiving server.

42. The golf ball order requesting terminal according to claim 41, wherein said receipt information input support information includes price information in accordance with the method of receiving said golf ball.

43. A golf ball order requesting terminal for requesting an order of a golf ball printed with a mark containing at least one of an optional character and an optional graphic design through a network, comprising:
a display section for displaying previous order information of an order requester, said previous order information sent from an order receiving server connected to said network; and
means for generating order information on the basis of said previous order information displayed on said display section, said generated order information sent to said order receiving server.
